(19) United States
(12) Patent Application Publication
(10) Pub. No.: US 2005/0080366 A1
(43) Pub. Date: Apr. 14, 2005

(54) Pneumatic stimulator array

(76) Inventor: William B. Cushman, Pensacola, FL (US)

Correspondence Address: NAVAL MEDICAL RESEARCH CENTER;ATTN: (CODE 00L), 503 ROBERT GRANT AVENUE, SILVER SPRING, MD, 20910-7500, US

(21) Appl. No.: 10/681,100

(22) Filed: Oct. 9, 2003

(51) Int. Cl. A61H 23/04

(52) U.S. Cl. 601/148

(57) ABSTRACT

An array of pneumatic stimulating nodes with integral pneumatically operable ANDing is disclosed. These stimulating nodes may be used to convey spatial orientation information to an individual in an attitudinally ambiguous situation via direct stimulation of his skin. The stimulating nodes of the instant invention may be arranged orthogonally in an array if this is convenient, or in a wide range of other configurations. The pneumatic stimulating nodes of the invention are comprised of three layers, and upper layer, diaphragm layer, and a lower layer which may be separately injection molded from suitable materials, for example, urethane thermoplastic elastomer, and fused together using radio-frequency welding techniques to form the complete stimulating array.

### BACKGROUND OF THE INVENTION

1. Field of Invention

This invention relates to stimulus arrays, more particularly to tough and resilient pneumatic stimulus arrays that may be developed proximal to the skin of a use, and that may be manufactured cheaply with minimum number of operations.

2. Description of the Related Art

Recently, the U.S. Naval Aerospace Medical Research Laboratory (NAMRL) at Pensacola, Fla., demonstrated complete and reliable control of aircraft attitude by a pilot flying with a blindfold in place. This was a remarkable feat, especially when it is remembered that not even a goose will fly blind in a fog. Geese released in a cloud will extend their wings upward so that their body becomes a pendulous gravity sensor and fall feet-first until they either land or clear the cloud. Attitude control was achieved by the NAMRL pilot by appraising him of his spatial orientation with an array of stimulators arranged about his torso. These stimulators were driven by a computer that had as its main input the attitude gyroscope of the aircraft. By freeing the visual system from the need to maintain attitude input, the pilot may direct sense to other, perhaps more useful tasks.

Spatial disorientation is the cause of a significant number of accidents within the aviation community, and the need to avoid spatial disorientation by attending to attitude instruments visually is a major source of work load for an aviator. Stimulator arrays with large numbers of nodes which are used to convey attitude information are clearly of benefit to the aviation community, but may also prove useful in space, underwater, and in training and simulation. Electrical approaches, however, such as vibrators, etc., are expensive to implement and vulnerable to many forms of damage. A pneumatic approach to an array stimulator has the benefit of being very rugged, is easy and inexpensive to assemble, and the same air pressure used to operate the logic of the array can be used as the information containing stimulus when directed toward the user's skin as a jet of air.

### SUMMARY OF THE INVENTION

Accordingly, an object of the instant invention is to provide an improved stimulating array for conveying information to a user via his skin.

Another object of the instant invention is to provide an improved stimulating array that is pneumatically operated.

Another object of the instant invention is to provide an improved stimulating array where each node is inherently an AND gate and may thereby form an individually addressable node in a larger array, thus reducing the number of valves required to operate the array.

Another object of the instant invention is to provide an improved stimulating array where the pneumatic pressure used to operate the pneumatic logic of each node may also be used as the stimulus air supply.

Another object of the instant invention is to provide an improved stimulating array that is extremely rugged.

A further object of the instant invention is to provide an improved stimulating array that is readily manufacturable at low cost.

These and additional objects of the invention are accomplished with a plurality of pneumatic stimulating nodes that are each comprised of input and output pneumatic lines that are logically ANDed internally to enable a stimulus output. The stimulating nodes of the instant invention may be arranged orthogonally in an array if this is convenient, but orthogonal orientation is not necessary for the array to function. The manufacture of pneumatic stimulating arrays according to the teaching of the instant invention with any number of nodes may be accomplished with as little as four steps. The pneumatic stimulating nodes of the instant invention are comprised of three layers, and upper layer, a diaphragm layer, and a lower layer which may be separately injection molded from suitable materials, for example urethane thermoplastic elastomer, and fused together using radio-frequency welding techniques to form the complete stimulating array.

### BRIEF DESCRIPTION OF THE DRAWINGS

In the following description of the preferred embodiments and the accompanying drawings, like numerals in different figures represent the same structures or elements. Proportional relationships are shown as approximations.

FIG. 1 shows a cross sectional view of an embodiment of a single pneumatic stimulating node of the instant invention in the non-operated state.

FIG. 2 shows a cross sectional view of an embodiment of a single pneumatic stimulating node of the instant invention shown in FIG. 1 when operated.

FIG. 3 shows a view of an embodiment of a single pneumatic stimulating node of the instant invention shown in FIGS. 1 and 2 and further shows the pneumatic lines of the instant invention.

FIG. 4 shows a view of a plurality of embodiments of the pneumatic stimulating nodes of the instant invention shown in FIGS. 1, 2 and 3 as they may be disposed in an array.

### DETAILED DESCRIPTION OF THE PREFERRED EMBODIMENTS

The parts indicated on the drawings by numerals are identified below to aid in the reader's understanding of the present invention.
11. Pneumatic stimulating node.
12. Upper layer.
13. Diaphragm layer.
14. Upper cavity.
15. Lower layer.
16. Lower cavity.
17. Valve stem.
18. Vavle seat.
19. Upper cavity air line.
20. Upper cavity air line.
21. Lower cavity air line.

FIG. 1 shows a cross sectional view of an embodiment of a single pneumatic stimulating node of the instant invention in the non-operated state. In FIG. 1, 11 indicates the pneumatic stimulating node generally, 12 indicates the upper layer of the pneumatic stimulating node, and 13 indicates the diaphragm layer of the stimulating node. The upper cavity, 14, of the pneumatic stimulating node, 11, may be pressurized with an air line not shown in this figure. The lower layer, 15, of pneumatic stimulating node, 11, and the diaphragm layer, 13, enclose lower cavity, 16, which may be pressurized with an air line not shown in this figure. A valve stem, 17 is an integral part of diaphragm layer, 13, and rests against valve seat, 18, which is an integral part of lower layer, 15.

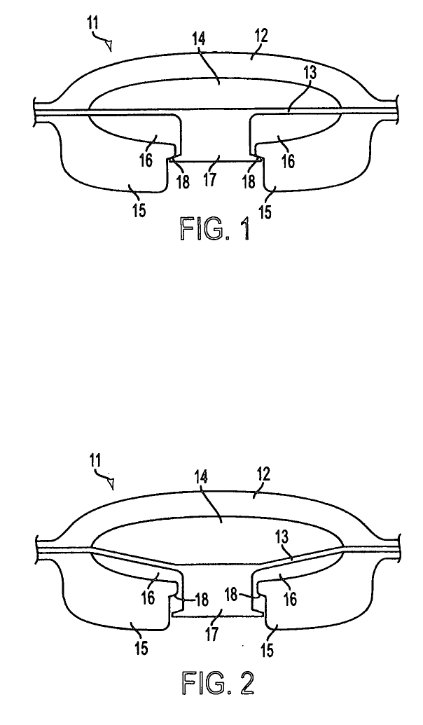

In a preferred embodiment of the instant invention the upper and lower layers, 12, and 15, would be injection molded from urethane thermoplastic elastomer with a relatively hard durometer, preferably in the range of 95 Shore A. The diaphragm layer, 13, is made from a similar urethane material but with a lower durometer of about 70 Shore A. The thickening of the upper and lower layers shown in FIGS. 1 and 2 should be sufficient to support the internal cavities of the instant invention against collapse from external pressures caused by clothing, etc., and the thinned areas between nodes should be thin enough to allow flexibility of the whole array.

The diaphragm layer, 13, of the pneumatic stimulating node, 11, shown in FIG. 1 will remain in the neutral position shown under two conditions: pressure in lower cavity, 16, with no pressure in upper cavity, 14, and no pressure in both upper cavity, 14, and lower cavity, 16.

FIG. 2 shows a cross sectional view of an embodiment of a single pneumatic stimulating node of the instant invention shown in FIG. 1 when operated. In FIG. 2, 11 indicates the pneumatic stimulating node generally, 12 indicates the upper layer of the pneumatic stimulating node, and 13 indicates the diaphragm layer of the pneumatic stimulating node. The upper cavity, 14, of the pneumatic stimulating node, 11, may be pressurized with an air line now shown in this figure. The lower layer, 15, of pneumatic stimulating node, 11, and the diaphragm layer, 13, enclose lover cavity, 16, which may be pressurized with an air line now shown in this figure. A valve stem, 17, is an integral part of diaphragm layer, 13, and is shown unseated from valve seat, 18, which is an integral part of lower layer, 15.

The diaphragm layer, 13, of the pneumatic stimulating node, 11, shown in FIG. 2 will extend downward, thus unseating valve stem, 17, from valve seat, 18, under two conditions: pressure in both lower cavity, 16, and upper cavity, 14, and with no pressure in lower cavity, 16, and with pressure in upper cavity, 14.

There are, therefore, four conditions that can be present within the pneumatic stimulating node of the instant invention. A stimulus output only occurs, however, when valve stem, 17, unseats from valve, 18, and air pressure is present in lower cavity, 16. These conditions are summarized in Table 1.

TABLE 1
Pneumatic stimulus node logic table.

| Upper cavity, 14, | Lower cavity, 16, | Stimulus |
|---|---|---|
| pressurized | pressurized | output |
| No | No | No |
| No | Yes | No |
| Yes | No | No |
| Yes | Yes | Yes |

The results shown in table 1 may be explained as follows. When both the upper and lower cavities, 14, and 15, of FIGS. 1 and 2, are not pressurized the result shown in row one of table 1, no stimulus output, is obvious as no pressurized air is present. When the lower cavity, 16, alone is pressurized, as is shown in row two of Table 1, there is no stimulus output because the air pressure in lower cavity, 16, will force the diaphragm layer, 13, upward, thus causing valve stem, 17, to seal firmly against valve seat, 18. When upper cavity, 14, is pressured, as shown in row three of Table 1, there is no stimulus output because there is no air pressure in lower cavity, 16, to supply stimulus air. Finally, when both upper cavity, 14, and lower cavity, 16, are pressurized (presumably at nearly the same pressure) then diaphragm layer, 13, is forced downward and valve stem, 17, will clear valve seat, 10, thus allowing stimulus air to flow because of the greater area of air pressure operating against diaphragm layer, 13, from upper cavity, 14, relative to the area in lower cavity, 16, which is reduced in area by the valve stem, 17.

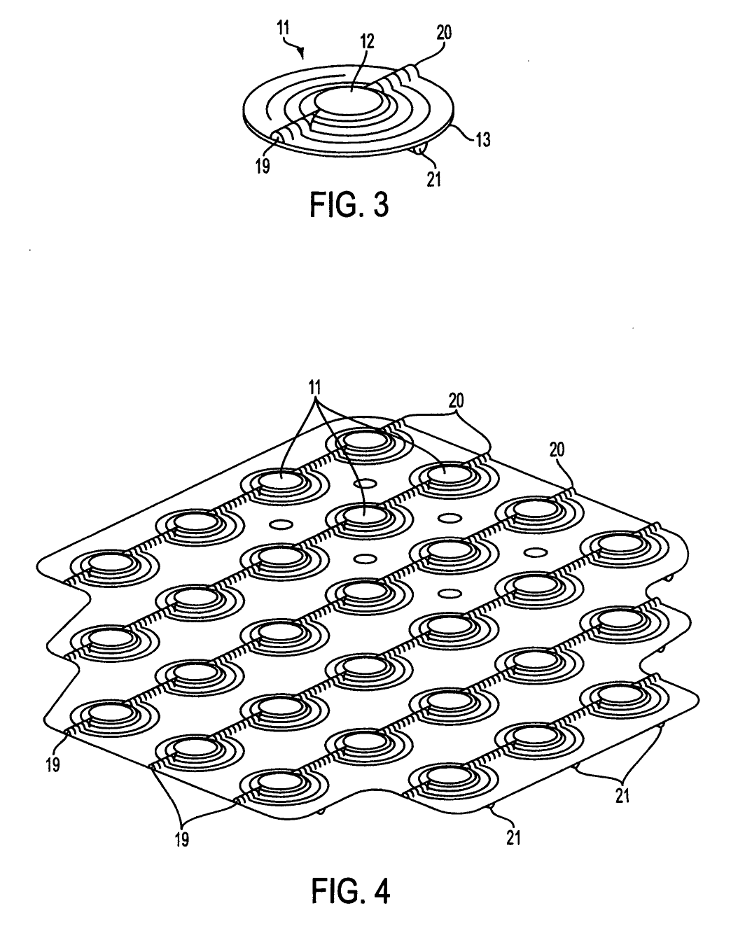

FIG. 3 shows a view of an embodiment the single pneumatic stimulating node of the instant invention shown in FIGS. 1 and 2 and further shows one possible configuration of the pneumatic lines of the instant invention. In FIG. 3, 11 is a pneumatic stimulus node of the instant invention, 12, is the upper layer of the instant invention, 13, is the diaphragm layer of the instant invention, 19 is an upper cavity air line, 20, is an additional upper cavity air line which may be used for a second pneumatic stimulus node amongst a plurality of said nodes, and 21 is a lower cavity air line.

FIG. 4 shows a view of a plurality of embodiments of the pneumatic stimulus nodes of the instant invention shown in FIGS. 1, 2 and 3 as they may be disposed in an array. In FIG. 4, 11 are pneumatic stimulating nodes of the instant invention, 19 and 20 are upper cavity air lines, and 21 are lower cavity air lines.

Many modifications and variations of the present invention are possible in light of the above teachings. For example, a different number of air lines could be used of they could be configures differently than is shown in the Figures. Different materials could be employed than have been described for the preferred embodiment above. Each pneumatic stimulus node could be made individually with separately attached pneumatic lines. It is therefore to be understood that, within the scope of the appended claims, the instant invention may be practiced otherwise than as specifically described.

1. A pneumatic stimulating node comprised of an upper cavity contiguously connected to a source of operating fluid pressure, a lower cavity contiguously connected to a source of operating fluid pressure, a diaphragm disposed between said upper and lower cavities with integral attached valve which when opened forms a contiguous pathway for the operating fluid within one of said cavities of the instant invention to an external area, said valve being operably opened when pressure is applied to the said cavity not contiguously opened to said external area by said valve.

2. The pneumatic stimulating node of claim 1 with control valves controlling the transmission of fluid pressure to the upper and lower cavities of the instant invention.

3. A plurality of the pneumatic stimulating nodes of claim 1 disposed in an array.

4. A plurality of the pneumatic stimulating nodes of claim 1 disposed in an array and connected with commonly contiguous fluid pressure sources whereby logical ANDing of operating fluid sources may be used to selectively operate individual nodes.

5. The pneumatic stimulating node of claim 1 manufactured from elastomeric materials.

6. The pneumatic stimulating node of claim 1 manufactured from elastomeric materials and non-elastomeric materials.
